(19) United States
(12) Patent Application Publication
(10) Pub. No.: US 2024/0039846 A1
(43) Pub. Date: Feb. 1, 2024

(54) Asymmetric Addressing For Limited Domains and Internet

(71) Applicant: Huawei Technologies Co., Ltd., Shenzhen (CN)

(72) Inventors: Kiran Makhijani, Santa Clara, CA (US); Lijun Dong, Santa Clara, CA (US)

(21) Appl. No.: 18/487,838

(22) Filed: Oct. 16, 2023

Related U.S. Application Data
(63) Continuation of application No. PCT/US2022/024677, filed on Apr. 13, 2022.
(60) Provisional application No. 63/174,921, filed on Apr. 14, 2021.

(51) Int. Cl. H04L 45/741; H04L 45/00; H04L 45/748

(52) U.S. Cl. CPC H04L 45/741; H04L 45/566; H04L 45/748

(57) ABSTRACT

A mechanism operating in a border router is disclosed. The mechanism includes receiving an upstream packet over a limited domain network (LDN). The upstream packet comprises a source address including a LDN suffix. The source address is translated into Internet Protocol version six (IPv6) format by applying a function to translate the LDN suffix into an IPv6 suffix. The upstream packet is forwarded over an IPv6 network based on the source address in IPv6 format.

### CROSS-REFERENCE TO RELATED APPLICATIONS

This patent application is a continuation of International Patent Application Publication No. PCT/US2022/024677, filed Apr. 13, 2022 by Kiran Makhijani, et al., and titled “Asymmetric Addressing For Limited Domains and Internet”, which claims the benefit of U.S. Provisional Patent Application No. 63/174,921, filed Apr. 14, 2021 by Kiran Makhijani, et al., and titled “Asymmetric Addressing Within Limited-Domains and Over Internet”, which is hereby incorporated by reference in its entirety.

### TECHNICAL FIELD

The present disclosure is generally related to network communications, and is specifically related to mechanisms for automated address management when communicating between user defined limited domain networks (LDNs) and internet protocol (IP) based networks used in the Internet.

### BACKGROUND

Most commercial communication networks communicate via the IP protocol. In contrast, industrial networks, such as a factory floor, often employ many specialized devices that communicate via different communication protocols. Many different specialized protocols are used in industrial networks, and each such protocol employs a different packet format. Accordingly, communicating between different portions of an industrial network is achieved only with great difficulty. For example, many specialized gateways may be employed inside an industrial network to allow industrial network devices to communicate, and such gateways may be manually configured in a stateful manner by an administrator for each device added to the network. Further, cloud computing resources are often separated from the industrial network via an IP network, and communication between an IP network and an industrial network is often unfeasible due to differences in communication protocols. As such, integration of industrial network devices with cloud computing systems is often unfeasible.

### SUMMARY

In an embodiment, the disclosure includes a method implemented by a border router, the method comprising: receiving an upstream packet over a limited domain network (LDN), the upstream packet comprising a source address in LDN format including an LDN suffix; translating the source address into Internet Protocol version six (IPv6) format by applying a function to translate the LDN suffix into an IPv6 suffix; and forwarding the upstream packet over an IPv6 network based on the source address in IPv6 format as included in the upstream packet.

The present example includes a series of mechanisms to configure communication between different addressing schemes used in different protocols. Such mechanisms are automated and mostly stateless, and hence avoid manual configuration and storage of large address translation tables. Such mechanisms also limit the usage of gateways for translation, and hence reduce network complexity. In an example, an industrial network is configured to operate in a limited domain network (LDN), which may include a plurality of subnetworks, also called subnets. Each subnetwork may include devices that operate using a separate protocol with a different address format and/or addressing scheme. The devices may communicate across subnetworks by employing addresses with different formats. For example, a source address can be in a format used in a first subnet and a destination address may be in a format used in a second subnet. Communication packets can be configured to indicate which format is used for each address. As an example, a New IP packet can be configured to support asymmetric addressing. Further, asymmetric addressing can also be used to communicate between an IP network and the industrial network. In an example, a New IP packet can carry a source address in an LDN format and a destination address in an IP format. A border router at the edge of the industrial network can be configured to translate between an LDN format and an IP format, and can further be configured to translate between IP and New IP headers. Accordingly, the border gateway and New IP can be used to allow an industrial network in an LDN to communicate with cloud computing systems over the Internet. Such translations can be made using reversible translation functions to allow for stateless communications. Further, this technique can be extended to allow an industrial network in an LDN to communicate with a different industrial network in a different LDN via the Internet. In an example, an LDN suffix can be translated into an IPv6 suffix via a reversible function and/or via a hash function. A mapping can be used to look up an IPv6 prefix for the destination domain. This allows a user defined LDN address to be translated into a useable IPv6 address for communication across an IP network. Further, the IPv6 address can be converted back to an LDN address by translating the IPv6 suffix into an LDN suffix via a translation function. The IPv6 prefix can either be translated into an LDN suffix or dropped, depending on the LDN address format size. The translations may be performed based on data in a forwarding information base (FIB), which may be updated via routing protocols. Further, the LDN address may be used as part of a user defined address family used for an industrial communication protocol, such as Modbus, Building Automation and Control networks (BACNet), Process Field Bus (ProfiBus), etc. It should be noted that the present disclosure describes conversion between an LDN address space and an IPv6 address space. However, the described mechanisms may be used to convert between the LDN address space and any network address space and/or network protocol. Hence, the present disclosure should not be limited to IPv6.

Optionally, in any of the preceding aspects, another implementation of the aspect provides, wherein the function is a hash function.

Optionally, in any of the preceding aspects, another implementation of the aspect provides, wherein the function is a reversible function.

Optionally, in any of the preceding aspects, another implementation of the aspect provides, wherein the source address in LDN format includes an LDN prefix, and wherein translating the source address in LDN format into IPv6 format includes obtaining an IPv6 global routing prefix mapped to the LDN prefix.

Optionally, in any of the preceding aspects, another implementation of the aspect provides, wherein the upstream packet is received as a New IP packet with the LDN prefix and the LDN suffix contained in a shipping specification.

Optionally, in any of the preceding aspects, another implementation of the aspect provides, wherein the LDN suffix is in a user defined format without a fixed address length.

Optionally, in any of the preceding aspects, another implementation of the aspect provides, wherein the LDN suffix contains a device address in Modbus format, Building Automation and Control networks (BACNet) format, Process Field Bus (ProfiBus) format, or combinations thereof.

Optionally, in any of the preceding aspects, another implementation of the aspect provides, wherein the LDN prefix is an LDN name, and wherein the LDN suffix contains an application type, a subnet type, and a device name.

Optionally, in any of the preceding aspects, another implementation of the aspect provides, wherein the function translates the application type into an application identifier (ID), translates the subnet type into a subnet ID, and translates the device name into a device ID.

Optionally, in any of the preceding aspects, another implementation of the aspect provides, wherein the upstream packet, as received, comprises a destination address in IPv6 format and the source address in an LDN format.

Optionally, in any of the preceding aspects, another implementation of the aspect provides, further comprising: receiving a downstream packet over the IPv6 network, the downstream packet comprising a destination address in IPv6 format including the IPv6 global routing prefix and the IPv6 suffix; translating the destination address into an LDN format by applying a function to translate the IPv6 suffix into the LDN suffix; and forwarding the downstream packet over the LDN network based on the destination address in LDN format.

Optionally, in any of the preceding aspects, another implementation of the aspect provides, wherein translating the destination address into LDN format includes obtaining the LDN prefix mapped to the IPv6 global routing prefix.

Optionally, in any of the preceding aspects, another implementation of the aspect provides, wherein translating the destination address into LDN format includes discarding the IPv6 global routing prefix.

Optionally, in any of the preceding aspects, another implementation of the aspect provides, wherein the downstream packet, as forwarded, comprises a source address in IPv6 format and the destination address in the LDN format.

Optionally, in any of the preceding aspects, another implementation of the aspect provides, wherein the downstream packet is forwarded as a New IP packet with the LDN prefix and the LDN suffix contained in a shipping specification.

Optionally, in any of the preceding aspects, another implementation of the aspect provides, wherein translations are performed based on a forwarding information base (FIB), and wherein the FIB is updated based on Intermediate System to Intermediate System (ISIS) protocol, Open Shortest Path First (OSPF) protocol, Border Gateway Protocol (BGP), or combinations thereof.

In an embodiment, the disclosure includes a method implemented by a network device, the method comprising: obtaining data in a limited domain network (LDN) network; generating a packet containing the data, the packet containing a source address in an LDN format and a destination address in Internet Protocol version six (IPv6) format; and transmitting the packet over the LDN network.

The present example includes a series of mechanisms to configure communication between different addressing schemes used in different protocols. Such mechanisms are automated and mostly stateless, and hence avoid manual configuration and storage of large address translation tables. Such mechanisms also limit the usage of gateways for translation, and hence reduce network complexity. In an example, an industrial network is configured to operate in a limited domain network (LDN), which may include a plurality of subnetworks, also called subnets. Each subnetwork may include devices that operate using a separate protocol with a different address format and/or addressing scheme. The devices may communicate across subnetworks by employing addresses with different formats. For example, a source address can be in a format used in a first subnet and a destination address may be in a format used in a second subnet. Communication packets can be configured to indicate which format is used for each address. As an example, a New IP packet can be configured to support asymmetric addressing. Further, asymmetric addressing can also be used to communicate between an IP network and the industrial network. In an example, a New IP packet can carry a source address in an LDN format and a destination address in an IP format. A border router at the edge of the industrial network can be configured to translate between an LDN format and an IP format, and can further be configured to translate between IP and New IP headers. Accordingly, the border gateway and New IP can be used to allow an industrial network in an LDN to communicate with cloud computing systems over the Internet. Such translations can be made using reversible translation functions to allow for stateless communications. Further, this technique can be extended to allow an industrial network in an LDN to communicate with a different industrial network in a different LDN via the Internet. In an example, an LDN suffix can be translated into an IPv6 suffix via a reversible function and/or via a hash function. A mapping can be used to look up an IPv6 prefix for the destination domain. This allows a user defined LDN address to be translated into a useable IPv6 address for communication across an IP network. Further, the IPv6 address can be converted back to an LDN address by translating the IPv6 suffix into an LDN suffix via a translation function. The IPv6 prefix can either be translated into an LDN suffix or dropped, depending on the LDN address format size. The translations may be performed based on data in a forwarding information base (FIB), which may be updated via routing protocols. Further, the LDN address may be used as part of a user defined address family used for an industrial communication protocol, such as Modbus, Building Automation and Control networks (BACNet), Process Field Bus (ProfiBus), etc. It should be noted that the present disclosure describes conversion between an LDN address space and an IPv6 address space. However, the described mechanisms may be used to convert between the LDN address space and any network address space and/or network protocol. Hence, the present disclosure should not be limited to IPv6.

Optionally, in any of the preceding aspects, another implementation of the aspect provides, wherein the LDN format includes an address in Modbus format, Building Automation and Control networks (BACNet) format, Process Field Bus (ProfiBus) format, or combinations thereof.

Optionally, in any of the preceding aspects, another implementation of the aspect provides, wherein the packet is a New IP packet with the source address and the destination address contained in a shipping specification.

Optionally, in any of the preceding aspects, another implementation of the aspect provides, wherein the LDN format is in a user defined format without a fixed address length.

Optionally, in any of the preceding aspects, another implementation of the aspect provides, wherein the LDN format includes an LDN name, an application type, a subnet type, and a device name.

Optionally, in any of the preceding aspects, another implementation of the aspect provides, wherein the network device is a gateway, wherein obtaining the data includes receiving the data from a separate device, and wherein generating the packet includes translating the data into a New IP format.

Optionally, in any of the preceding aspects, another implementation of the aspect provides, wherein the network device comprises a sensor, and wherein the data is obtained by the sensor.

In an embodiment, the disclosure includes a network device comprising: a processor, a receiver coupled to the processor, a memory coupled to the processor, and a transmitter coupled to the processor, wherein the processor, receiver, memory, and transmitter are configured to perform the method of any of the preceding aspects.

In an embodiment, the disclosure includes a non-transitory computer readable medium comprising a computer program product for use by a router, the computer program product comprising computer executable instructions stored on the non-transitory computer readable medium such that when executed by a processor cause the router to perform the method of any of the preceding aspects.

In an embodiment, the disclosure includes a border router comprising: a receiving means for receiving an upstream packet over a limited domain network (LDN), the upstream packet comprising a source address in LDN format including an LDN suffix; a translating means for translating the source address into Internet Protocol version six (IPv6) format by applying a function to translate the LDN suffix into an IPv6 suffix; and a forwarding means for forwarding the upstream packet over an IPv6 network based on the source address in IPv6 format as included in the upstream packet.

The present example includes a series of mechanisms to configure communication between different addressing schemes used in different protocols. Such mechanisms are automated and mostly stateless, and hence avoid manual configuration and storage of large address translation tables. Such mechanisms also limit the usage of gateways for translation, and hence reduce network complexity. In an example, an industrial network is configured to operate in a limited domain network (LDN), which may include a plurality of subnetworks, also called subnets. Each subnetwork may include devices that operate using a separate protocol with a different address format and/or addressing scheme. The devices may communicate across subnetworks by employing addresses with different formats. For example, a source address can be in a format used in a first subnet and a destination address may be in a format used in a second subnet. Communication packets can be configured to indicate which format is used for each address. As an example, a New IP packet can be configured to support asymmetric addressing. Further, asymmetric addressing can also be used to communicate between an IP network and the industrial network. In an example, a New IP packet can carry a source address in an LDN format and a destination address in an IP format. A border router at the edge of the industrial network can be configured to translate between an LDN format and an IP format, and can further be configured to translate between IP and New IP headers. Accordingly, the border gateway and New IP can be used to allow an industrial network in an LDN to communicate with cloud computing systems over the Internet. Such translations can be made using reversible translation functions to allow for stateless communications. Further, this technique can be extended to allow an industrial network in an LDN to communicate with a different industrial network in a different LDN via the Internet. In an example, an LDN suffix can be translated into an IPv6 suffix via a reversible function and/or via a hash function. A mapping can be used to look up an IPv6 prefix for the destination domain. This allows a user defined LDN address to be translated into a useable IPv6 address for communication across an IP network. Further, the IPv6 address can be converted back to an LDN address by translating the IPv6 suffix into an LDN suffix via a translation function. The IPv6 prefix can either be translated into an LDN suffix or dropped, depending on the LDN address format size. The translations may be performed based on data in a forwarding information base (FIB), which may be updated via routing protocols. Further, the LDN address may be used as part of a user defined address family used for an industrial communication protocol, such as Modbus, Building Automation and Control networks (BACNet), Process Field Bus (ProfiBus), etc. It should be noted that the present disclosure describes conversion between an LDN address space and an IPv6 address space. However, the described mechanisms may be used to convert between the LDN address space and any network address space and/or network protocol. Hence, the present disclosure should not be limited to IPv6.

Optionally, in any of the preceding aspects, another implementation of the aspect provides, wherein the border router is further configured to perform the method of any of the preceding aspects.

In an embodiment, the disclosure includes a network device comprising: an obtaining means for obtaining data in a limited domain network (LDN) network; a generating means for generating a packet containing the data, the packet containing a source address in an LDN format and a destination address in Internet Protocol version six (IPv6) format; and a transmitting means for transmitting the packet over the LDN network.

The present example includes a series of mechanisms to configure communication between different addressing schemes used in different protocols. Such mechanisms are automated and mostly stateless, and hence avoid manual configuration and storage of large address translation tables. Such mechanisms also limit the usage of gateways for translation, and hence reduce network complexity. In an example, an industrial network is configured to operate in a limited domain network (LDN), which may include a plurality of subnetworks, also called subnets. Each subnetwork may include devices that operate using a separate protocol with a different address format and/or addressing scheme. The devices may communicate across subnetworks by employing addresses with different formats. For example, a source address can be in a format used in a first subnet and a destination address may be in a format used in a second subnet. Communication packets can be configured to indicate which format is used for each address. As an example, a New IP packet can be configured to support asymmetric addressing. Further, asymmetric addressing can also be used to communicate between an IP network and the industrial network. In an example, a New IP packet can carry a source address in an LDN format and a destination address in an IP format. A border router at the edge of the industrial network can be configured to translate between an LDN format and an IP format, and can further be configured to translate between IP and New IP headers. Accordingly, the border gateway and New IP can be used to allow an industrial network in an LDN to communicate with cloud computing systems over the Internet. Such translations can be made using reversible translation functions to allow for stateless communications. Further, this technique can be extended to allow an industrial network in an LDN to communicate with a different industrial network in a different LDN via the Internet. In an example, an LDN suffix can be translated into an IPv6 suffix via a reversible function and/or via a hash function. A mapping can be used to look up an IPv6 prefix for the destination domain. This allows a user defined LDN address to be translated into a useable IPv6 address for communication across an IP network. Further, the IPv6 address can be converted back to an LDN address by translating the IPv6 suffix into an LDN suffix via a translation function. The IPv6 prefix can either be translated into an LDN suffix or dropped, depending on the LDN address format size. The translations may be performed based on data in a forwarding information base (FIB), which may be updated via routing protocols. Further, the LDN address may be used as part of a user defined address family used for an industrial communication protocol, such as Modbus, Building Automation and Control networks (BACNet), Process Field Bus (ProfiBus), etc. It should be noted that the present disclosure describes conversion between an LDN address space and an IPv6 address space. However, the described mechanisms may be used to convert between the LDN address space and any network address space and/or network protocol. Hence, the present disclosure should not be limited to IPv6.

Optionally, in any of the preceding aspects, another implementation of the aspect provides, wherein the network device is further configured to perform the method of any of the preceding aspects.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of an example network configured for communication between a limited domain network (LDN) and an Internet Protocol (IP) version six (IPv6) network.

FIG. 2 is a diagram of an example LDN containing a border router configured to communicate data between subnets.

FIG. 3 is a protocol diagram of an example mechanism of communicating data between a network device in an LDN and an application server via an IP network.

FIG. 4 is a diagram of an example New IP packet that can be used to carry data across both an LDN and an IP network.

FIG. 5 is a diagram of an example mechanism for mapping an LDN address to an IPv6 address.

FIG. 6 is a diagram of an example network element.

FIG. 7 is a flowchart of an example method of translating addresses to support communication across a boundary between an LDN and an IP network.

FIG. 8 is a flowchart of an example method of communicating a packet containing addresses in both LDN and IP format.

FIG. 9 is a diagram of an example system for communicating data using addresses in LDN and IP formats.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are a series of mechanisms to configure communication between different addressing schemes used in different protocols. Such mechanisms are automated and mostly stateless, and hence avoid manual configuration and storage of large address translation tables. Such mechanisms also limit the usage of gateways for translation, and hence reduce network complexity. In an example, an industrial network is configured to operate in a limited domain network (LDN), which may include a plurality of subnetworks, also called subnets. Each subnetwork may include devices that operate using a separate protocol with a different address format and/or addressing scheme. The devices may communicate across subnetworks by employing addresses with different formats. For example, a source address can be in a format used in a first subnet and a destination address may be in a format used in a second subnet. Communication packets can be configured to indicate which format is used for each address. As an example, a New IP packet can be configured to support asymmetric addressing. Further, asymmetric addressing can also be used to communicate between an IP network and the industrial network. In an example, a New IP packet can carry a source address in an LDN format and a destination address in an IP format. A border router at the edge of the industrial network can be configured to translate between an LDN format and an IP format, and can further be configured to translate between IP and New IP headers. Accordingly, the border gateway and New IP can be used to allow an industrial network in an LDN to communicate with cloud computing systems over the Internet. Such translations can be made using reversible translation functions to allow for stateless communications. Further, this technique can be extended to allow an industrial network in an LDN to communicate with a different industrial network in a different LDN via the Internet. In an example, an LDN suffix can be translated into an IPv6 suffix via a reversible function and/or via a hash function. A mapping can be used to look up an IPv6 prefix for the destination domain. This allows a user defined LDN address to be translated into a useable IPv6 address for communication across an IP network. Further, the IPv6 address can be converted back to an LDN address by translating the IPv6 suffix into an LDN suffix via a translation function. The IPv6 prefix can either be translated into an LDN suffix or dropped, depending on the LDN address format size. The translations may be performed based on data in a forwarding information base (FIB), which may be updated via routing protocols. Further, the LDN address may be used as part of a user defined address family used for an industrial communication protocol, such as Modbus, Building Automation and Control networks (BACNet), Process Field Bus (ProfiBus), etc. It should be noted that the present disclosure describes conversion between an LDN address space and an IPv6 address space. However, the described mechanisms may be used to convert between the LDN address space and any network address space and/or network protocol. Hence, the present disclosure should not be limited to IPv6.

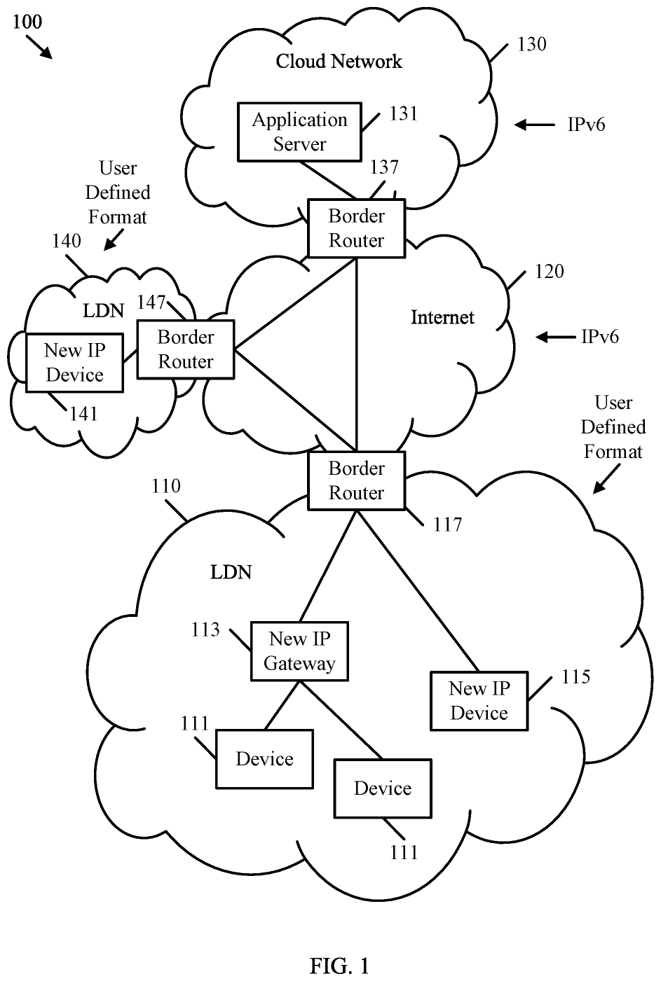

FIG. 1 is a diagram of an example network 100 configured for communication between an LDN and an IPv6 network. The network 100 includes a first LDN 110 communicatively coupled to a second LDN 140 and a cloud network 130 via a core network 120 operating a portion of the Internet. An LDN, such as the first LDN 110 and the second LDN 140, is a network with a domain boundary that connects to the Internet and employs administratively defined protocols, semantics, and/or addressing mechanisms within the domain boundary that are not used and/or not understood by the Internet. Many types of LDNs exist, such as a home network, a small office network, a vehicle network, a supervisory control and data acquisition (SCADA) network, a sensor network, an internet of things (IoT) network, a managed wide area network, a content delivery network, etc. While applicable to any LDN, the present disclosure focuses on a scenario where the LDN is an industrial network, such as a factory floor with groups of sensors, specialized automated machinery, and/or control systems networked together to perform specialized tasks.

The first LDN 110 contains various interconnected network nodes. For example, the first LDN 110 includes devices 111. A device 111 may be any component that performs a function and communicates data over a network related to the function. For example, a device 111 may include a sensor, a machine, a component of a machine, etc. Devices 111 may communicate with a specialized protocol that does not interface with IP. For example, a device 111 may be a legacy component configured to communicate data via Modbus, Building Automation and Control networks (BACNet), Process Field Bus (ProfiBus), Controller Area Network bus (CANbus), and/or other non-IP based communication protocols. As an example, a device 111 may be a sensor that senses a condition and communicates the sensed condition via the corresponding communication protocol. As another example, a device 111 may be a machine (e.g., a robotic arm, a welding machine, a sewing machine, etc.) that performs a function based on commands received via the corresponding communication protocol. The first LDN 110 may contain many such devices 111 that may or may not share the same communication protocol. Accordingly, the first LDN 110 employs communication packets formatted according to one or more user defined formats.

In order to allow devices 111 in the first LDN 110 to communicate, the first LDN 110 employs a New IP signaling mechanism. New IP is an emerging highly customizable communications framework designed to interface with a large number of network systems. While New IP includes a significant number of functions not available in IP, the present disclosure focuses on the New IP addressing mechanism. New IP allows addresses to be included in any format and allows addresses to be any number of bits. Accordingly, the present disclosure uses New IP to support asymmetric addressing. As used herein, asymmetric addressing occurs when a source address and a destination address include different address formats. For example, a New IP packet can include a source address formatted according to a first protocol and a destination address formatted according to a second protocol. As such, New IP can be used to communicate data between devices 111 that use different communication protocols. Further, New IP packets have no required packet size, and hence can carry payloads created by any source protocol. New IP is used in the present disclosure only as an example, and is continuing to be developed. It will be understood that other protocols with features similar to New IP (for example, asymmetric addressing), including future versions of New IP itself, can also be used to achieve the same functionality described herein. Thus, said use of other protocols with similar features is also considered part of the present disclosure.

For example, the first LDN 110 can contain New IP gateways 113. A New IP gateway 113 is a communication device positioned between subnets that employ different communication protocols in the first LDN 110. A New IP gateway 113 can reformat data received from a downstream device 111 in a first protocol (e.g., Modbus) into New IP format. The New IP gateway 113 can then transmit the data to another New IP gateway 113 for translation into a second protocol (e.g., Profibus) for presentation to a different device 111 via the second protocol. The first LDN 110 may also include New IP devices 115, which may be substantially similar to devices 111 but may be further configured to natively communicate via New IP (e.g., without needing translation by a New IP gateway 113). As with protocols with features similar to New IP, it will be understood that gateways and devices with similar features are also considered part of the present disclosure, and the New IP gateways and devices are used only as an example. For example, another type of gateway can reformat data received from a downstream device in a first protocol into another protocol.

The first LDN 110 also comprises a border router 117 at the edge of the first LDN 110 domain and connected to a core network 120 in the Internet. The border router 117 is configured to receive New IP packets with asymmetric addresses and convert the New IP packets into IP packets, such as IP version four to (IPv4) and/or IPv6 packets, and vice versa. IPv4, IPv6, and other versions of IP are used only as an example, and other formats can also be used in the core network according to this disclosure; and similarly, other address types can be used in a similar way as those standards are used in this disclosure. New IP packets have a similar structure to IP packets, and hence conversion can be performed by reformatting the New IP header into an IP header. However, IP packets have constraints on address sizes. Accordingly, the border router 117 is configured to translate the asymmetric addresses used by the LDN into IP format. For clarity of discussion, any address format used in an LDN is referred to as an LDN address format. An LDN address may include an LDN suffix and/or an LDN prefix depending on the length of the LDN address. In an example, the border router 117 can be configured to translate an LDN suffix into an IPv6 suffix. Such translation can include translation via a hash function and/or translation via a reversible function. An LDN prefix, if present, can also be mapped to an IPv6 prefix. When not present, the IPv6 prefix of a known destination can be looked up in a mapping table configured in the border router. The IPv6 prefix is sufficient to route the packet through an IPv6 network to the correct non-IPv6 destination network. Accordingly, the IPv6 suffix can be any procedurally generated value that can be used to recover the correct device 111 and/or New IP device 115 in the first LDN 110 for routing responsive packets.

The border router 117 can forward packets from the first LDN toward a cloud network 130 via the core network 120 in the Internet. A core network 120, also known as a backbone network, is a high capacity network that provides paths for connecting geographically diverse end networks. The core network 120 employs IPv6 and can communicate the IPv6 packets created by the border router 117 to any destination based on the destination addresses in the IPv6 packets. Because the LDN addresses have been converted into IPv6 format, the functionality of the core network 120 is not altered.

The cloud network 130 is a network in a data center that provides access to computing resources via elastic provisioning. In the present example, the cloud network 130 is configured to operate in IPv6 format and includes a border router 137 and an application server 131. The border router 137 performs security functions and performs network translation as desired. As with the core network 120, the functionality of the border router 137 is not altered because the LDN addresses have been converted into IPv6 format. As such, the border router 137 forwards the IPv6 packet toward the application server 131. The application server 131 can be a specific machine or a virtual machine operating on dynamically provisioned hardware resources in the cloud network 130. Accordingly, the disclosed mechanisms can use New IP and address translations to communicate data from devices 111 and/or New IP devices 115 that are configured for non-IP based communication and communicate such data across an IPv6 network. Hence, the disclosed mechanisms can provide geographically distant cloud computing power from an application server 131 to compute intensive tasks performed by industrial devices in a non-IP LDN. It should be noted that non-IP addresses/communication, as used herein, is another term for LDN addresses/communication. It should also be noted that, as used here, a non-IP device is a device that is not configured to receive, process, and/or transmit IP packets. A non-IP device may only communicate such packets via a gateway that performs packet translations.

In another example, the border router 137 can forward packets from the first LDN 110 toward a second LDN 140 via the core network 120 in the Internet. The second LDN 140 may be substantially similar to the first LDN 110. For example, the second LDN 140 includes a border router 147 and a new IP device 141, which are substantially similar to the border router 117 and new IP device 115, respectively. In an example, the New IP device 115 can generate a packet in New IP format with a source address set to the New IP device 115 and a destination address set to an address for the New IP device 141. The source address may be in a first LDN format native for the new IP device 115 and the destination address may be an IPv6 address associated with the New IP device 141. The packet can be sent to the border router 117, which translates the packet from New IP format into IP format. This includes translating the source address from the LDN format into an IP address that indicates the New IP device 115. Translation from New IP format into IP format is performed because the core network 120 is not configured to process New IP packets and further is not configured to read addresses in New IP format. Hence, the addresses are translated into an IP format that can be read and processed by the core network 120. In addition, LDN 110 may not require a sixteen-byte address as is used in IPv6. Often an address that is eight bytes or less is sufficient. Therefore, the LDNs may use shorter length addresses for space efficiency, and then the translation converts the smaller address space into the sixteen-byte address space used by IPv6.

The packet is forwarded from the border router 117 toward the border router 147 via the core network 120. The border router 117 translates the packet from IPv6 format back into New IP format. This includes translating the destination address from IPv6 format into a second LDN format native to the New IP device 141. The second LDN format may be the same format as the first LDN format or the two formats may be different. The border router 147 can then forward the packet in New IP format to the New IP device 141. The New IP device 141 can send data back to the New IP device 115 using a similar process. In this way, devices in different LDNs can communicate across an IP network. A similar process can also be used by devices 111 with the assistance of a New IP gateway 113. Accordingly, this mechanism can allow devices that are not natively IP compliant to communicate via the Internet, for example by using New IP as a shim layer. For example, a sensor in a first factory may use this process to send data to a control system in a different factory via the Internet. This may be advantageous for less sophisticated devices. For example, New IP contains many optional fields that can be avoided if not needed. Accordingly, New IP may be implemented on less complex (e.g., lower power) devices that would otherwise be unable to use IPv6 directly.

The border routers 117 and/or 147 can perform such translation based on a forwarding information base (FIB). The FIB can be updated with translation mechanisms and/or addresses by a management interface, software defined networking (SDN) API, or a routing protocol, such as Intermediate System to Intermediate System (ISIS) protocol, Open Shortest Path First (OSPF) protocol, Border Gateway Protocol (BGP), etc. By updating the rules in the FIB, the border routers 117 and/or 147 can dynamically perform such translations without requiring the translations to be configured for each new device added to the network 100. Such translations may be stateless on a per device basis. So long as IPv6 prefix for a destination border router can be determined (via a table or a domain name service (DNS) lookup), packets can be forwarded to the destination network without maintaining a state for each device in the destination network. This reduces complexity of the routing process from both a network maintenance and storage space perspective.

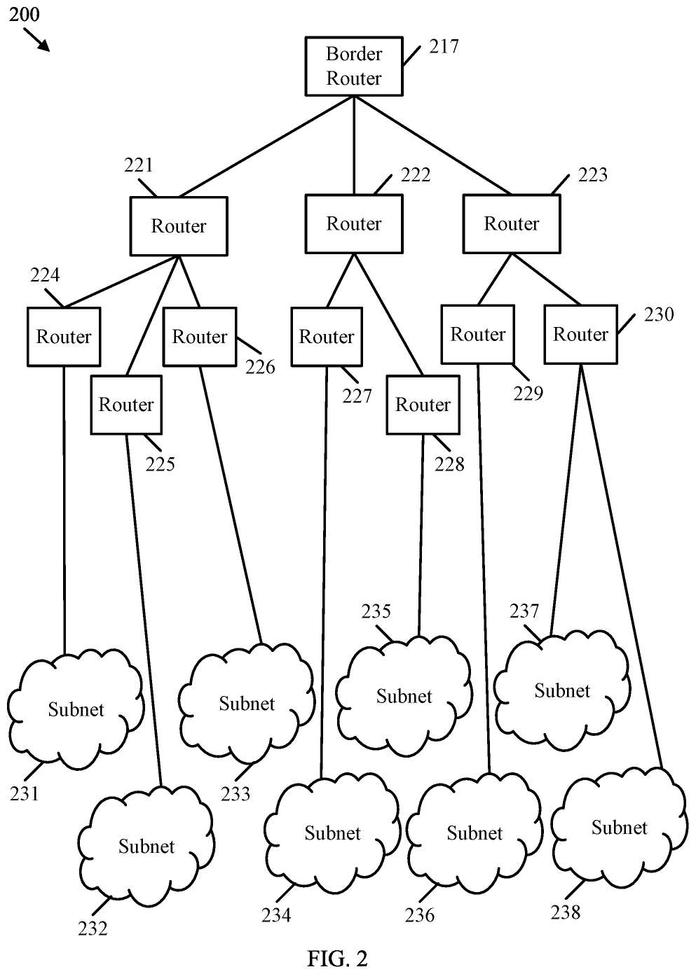

FIG. 2 is a diagram of an example LDN 200 containing a border router 217 configured to communicate data between subnets. LDN 200 is an example of a more detailed implementation of LDN 110. The LDN 200 includes a plurality of subnets denoted as subnet 231, subnet 232, subnet 233, subnet 234, subnet 235, subnet 236, subnet 237, and subnet 238. Each subnet is a subdomain in the LDN that is managed according to different administrative rules. For example, each subnet may employ different communication protocols, semantics, addressing schemes, etc. In an example, the addresses in each subnet may be locally significant and the components in each subnet may not be natively configured to communicate with components in other subnets. The subnets are configured to communicate with the Internet via the border router 217, which is substantially similar to border router 117. The subnets are communicatively coupled to the border router 217 by a series of routers as shown. In the example shown, subnet 231, subnet 232, subnet 233, subnet 234, subnet 235, subnet 236, and subnet 237, are coupled to router 224, router 225, router 226, router 227, router 228, and router 229, respectively. Subnets 237 and 238 are coupled to router 230. Router 224, router 225, and router 226 are coupled to router 221. Router 227 and router 228 are coupled to router 222. Router 229 and router 230 are coupled to router 223. Routers 221, 222, and 223 are coupled to border router 217.

In some examples, the routers may be configured to employ New IP. Accordingly, communications from a subnet that are not in New IP format can be translated into New IP format by the corresponding router and forwarded toward a destination subnet via the network of routers for translation into the local format at the destination subnet. Further, any communications destined to leave the LDN 200 can be forwarded to the border router for forwarding as discussed with respect to network 100. In the event that a subnet natively uses New IP, the routers can forward such communications without translation.

Further, LDN 200 can be configured to employ custom address families. An address family can be defined to be semantic, hierarchical, and/or encoded. In an example, a semantic address may fully describe names in understandable and/or readable strings. A hierarchical address can be split into parts, where each part includes a different format. This mixed format approach allows forwarding to be performed differently for each part of the address. This approach allows for both IP and non-IP forwarding rules to be applied to different portions of the address, and hence different subnets. Further, an encoded address family is configured to support application of a boundary protocol at a border router 217. For example, an encoded address family employs a format that supports translation to and from a usable IPv6 address via hashing and/or inverse function.

By using these approaches, network nodes can be grouped based on function, location, application type, or any other logical grouping that makes sense for a particular network. For example, all nodes that are included in a particular building, floor of a building, type of building, etc., could be grouped together into a subnet. In another example, network nodes related to particular functions, such as temperature sensors, motion related components, surveillance related components, etc. could be grouped into a subnet. This approach may allow network components that employ different native communication protocols to be grouped together into functional groups that can communicate via New IP (e.g., a subnet including both Modbus and Profibus components). Such components can then communicate with other subnets as desired by employing corresponding translation protocols. New IP supports such semantic and/or hierarchical groupings by allowing addresses to be any length. Such configurations can be referred to as an inside protocol from the perspective of the LDN 200. A network administrator can define forwarding lookup behavior for each user defined address family. A New IP router supports a separate forwarding table for each address family. Destination addresses and/or address types can be used to look up next hop information from the forwarding tables.

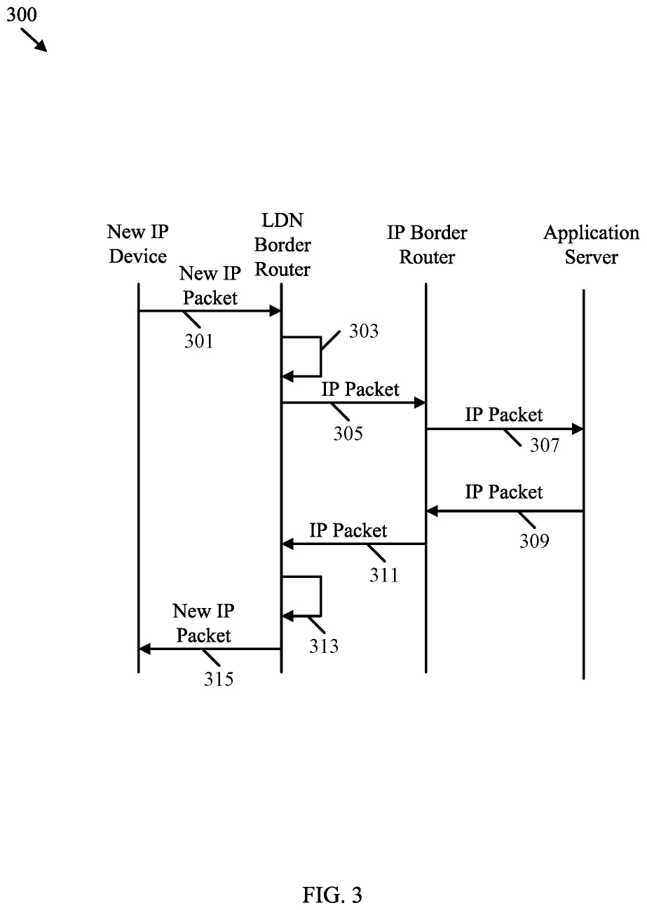

FIG. 3 is a protocol diagram of an example mechanism 300 of communicating data between a network device in an LDN, such as New IP device 115, and an application server, such as application server 131, via an IP network, such as a core network 120. At step 301, a New IP device determines to transmit an upstream packet to an application server in New IP format. The new IP device is included in an LDN, and hence may employ addresses generated based on an LDN address family. Accordingly, the New IP device may set the source address of the upstream packet as the address for the New IP device in LDN format. The New IP device sets the destination address of the upstream packet as the address of application server in IPv6 format in order to allow the upstream packet to be routed correctly over the Internet. The upstream packet is transmitted to an LDN border router.

At step 303, the LDN border router translates the upstream packet from New IP format into IP format. This translation may include translating the source address into IPv6 format by translating an LDN suffix into an IPv6 suffix and obtaining an IPv6 prefix mapped to the LDN address, such as an IPv6 global routing prefix associated with the LDN border router. An IPv6 global routing prefix is an address value assigned by a prefix-allocating agency directly or indirectly, such as an internet service provider (ISP), to a customer site which may contain an entire network. Accordingly, an IPv6 global routing prefix may be sufficient to route a packet to a gateway of a specified network via the Internet. The address translation may include applying a hashing function and/or an inverse function. Hashing may result in collisions. Accordingly, an LDN border router may maintain a reverse mapping with uniqueness guarantees when hashing is used.

At step 305 the upstream packet is forwarded to an IP border router via the Internet. The upstream packet is then forwarded to an application server at step 307. The application server may determine to transmit a corresponding downstream packet back to the New IP device. The application server sets the source address to the IPv6 address of the application server and sets the destination address to the IPv6 address for the New IP device as created by translation at step 303. The downstream packet is transmitted to the IP border router at step 309 and forwarded to the LDN border router via the Internet at step 311.

At step 313, the LDN border router translates the downstream packet from IP format into New IP format. This includes an inverse process of step 303. The destination address is translated into LDN format by translating the IP suffix into an LDN suffix via hashing (e.g., using an inverse mapping) and/or via applying an inverse of the function applied at step 303. The IPv6 prefix may be mapped to an LDN prefix or discarded, depending on the example. The downstream packet in New IP format can then be forwarded to the New IP device at step 315.

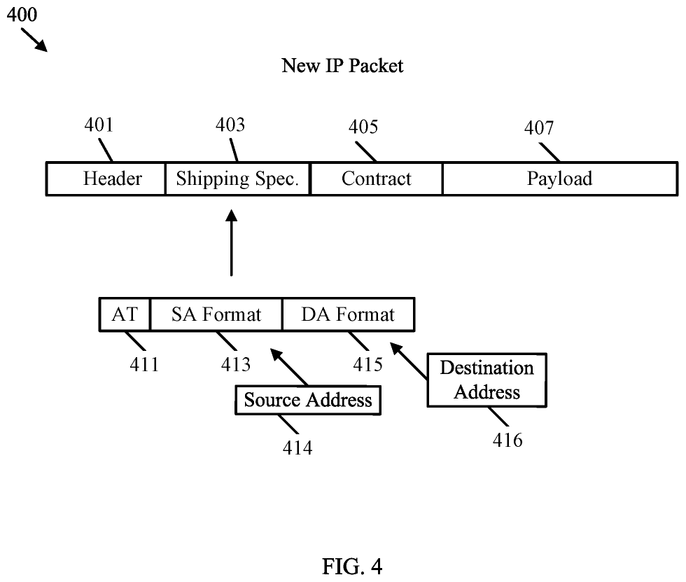

FIG. 4 is a diagram of an example New IP packet 400 that can be used to carry data across both an LDN and an IP network, for example as described with respect to network 100, LDN 200, and/or mechanism 300. The New IP protocol is a data plane protocol designed to support machine to machine communication and enhance user experience. The New IP protocol uses a New IP packet 400 to perform these features. New IP can coexist with IP network architecture while providing additional functionality.

The New IP packet 400 comprises a header 401, a shipping specification 403, a contract 405, and a payload 407. The New IP packet 400 has a variable length. Accordingly, the header 401 includes a series of offsets that act as pointers. A router receiving a New IP packet 400 can review the offsets in the header 401 to determine the location of corresponding data in the New IP packet 400. For example, the header 401 may comprise a shipping pointer, a contract pointer, and a payload pointer that point to the starting bits of the shipping specification 403, the contract 405, and the payload 407, respectively.

The shipping specification 403 indicates the source address and destination address. The shipping specification 403 employs a flexible addressing scheme. The shipping specification 403 contains an address type (AT) field 411 indicating the addressing format used. The shipping specification 403 may also contain one or more address cast field(s) indicating the nature of the communication, such as one to one, many to one, anycast, multicast, broadcast, coordinating casting, etc. The shipping specification 403 also contains a source address (SA) format field 413 and a destination address (DA) format field 415. The SA format field 413 contains the source address 414 for the New IP packet 400 as well as the length of the source address 414, which is included because the source address 414 is variable length. The DA format field 415 contains the destination address 416 for the New IP packet 400 as well as the length of the destination address 416, which is included because the destination address 416 is variable length. As can be seen, the AT field 411, the SA format field 413, and the DA format field 415 are flexible and can allow the New IP packet 400 to carry addresses in any combination for formats. Hence, the New IP packet 400 supports asymmetric addresses, address families, and other mechanisms that are user defined in an LDN.

The contract 405 is an optional field that may be used to dynamically program each node to provide requested services to packets and/or flows. IP networks attempt to guarantee service levels for users and/or flows in the aggregate, but can only retroactively determine whether such guarantees were actually met. The contract 405 directs the node to treat the current packet in a prescribed manner, and hence can ensure that guarantees are met in real time on a packet by packet basis. The contract 405 may include contract clauses and optionally metadata. The payload 407 is the actual data transmitted from a source to a destination across the data plane.

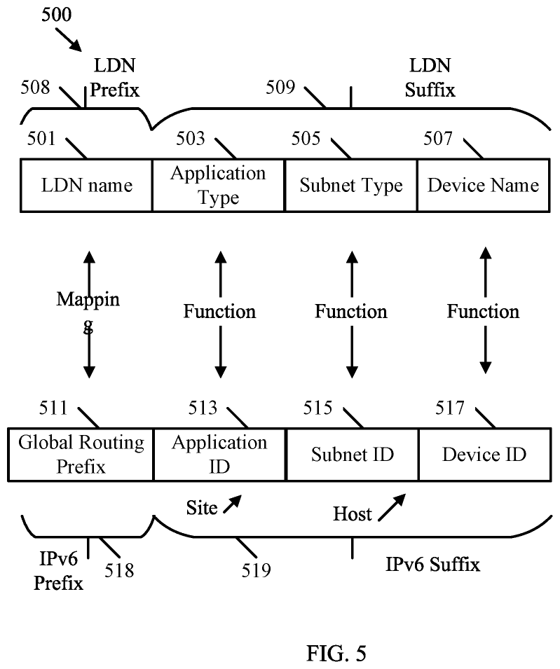

FIG. 5 is a diagram of an example mechanism 500 for mapping an LDN address to an IPv6 address. For example, mechanism 500 can be used while converting a New IP packet into an IPv6 packet and vice versa. Mechanism 500 can be applied to an LDN address. An LDN address is any address used in an LDN, such as LDN 110 and/or LDN 200. An LDN address can be defined by a systems administrator to operate based on rules that are applicable to the LDN. As such, an LDN address can be considered to be user defined. An LDN address comprises at least an LDN suffix 509 and may optionally comprise an LDN prefix 508. A prefix is the first portion of an address and a suffix is the last portion of an address. In an example, a prefix may be the first 64 bits of an address, and may uniquely identify a network. In an example, a suffix may be the last 64 bits of an address, and may uniquely identify a particular device and/or port of a device. However, an LDN address is of variable length, and hence the LDN prefix 508 may be omitted and the LDN suffix 509 may be smaller than 64 bits. Similarly, it will be understood that the arrangement of the prefix, suffix, and other components can vary. For example, an LDN address can optionally place features described herein as part of the “prefix” at and end of the address, and features described as part of the “suffix” at the beginning of the address.

In the present example, the LDN prefix 508 includes an LDN name 501. Further, the LDN suffix 509 includes an application type 503, a subnet type 505, and a device name 507. The LDN name 501 may uniquely identify a corresponding LDN. The LDN name 501 may be a semantic description of the LDN. A semantic description may be a natural language description, such as a name of an enterprise domain, a factory domain, etc. The semantic description may be determined based on global routing prefixes used in the Internet.

The application type 503 may indicate an application (e.g., a software, a function, etc.) associated with a corresponding device. The application type 503 may be used to categorize applications that function within the LDN. In an example, such application could include a smart home system, a smart building system, a manufacturing system, a factory system, etc. Such categorization can be made based on the general location of devices performing a function, an Internet of Things (IoT) application, etc. The subnet type 505 may indicate/identify a corresponding subnet within an LDN associated with a corresponding device. In some examples, the subnet indicated by subnet type 505 may be a concatenation of a hierarchy of subnets, such as [zone] [room] [wall] where [zone] indicates a zone including a general area within a structure, [room] indicates a room in the structure, and [wall] indicates a particular location/grouping within the room. The device name 507 may uniquely identify the device within the LDN. The device indicated by the device name 507 should be associated with the application and subnet indicated by the application type 503 and the subnet type 505.

For communication outside the LDN, a border router may translate the LDN address into an IPv6 address. The IPv6 address includes an IPv6 prefix 518 and an IPv6 suffix 519. The IPv6 prefix 518 includes a global routing prefix 511, which uniquely identifies a network in the Internet. The border router can map the LDN prefix 508 to the IPv6 prefix 518. For example, the semantic description in the LDN name 501 may be mapped to a global routing prefix 511 that can be determined using a domain name system (DNS) services.

The IPv6 suffix 519 includes fields that indicate a site and a host within the site. The border router can use a function to convert the application type 503 into an application ID 513 that indicates the application while functioning as an indicator of the site from an IPv6 perspective. In an example, the application type 503 can also be hashed to bits in IPv6 following global routing prefix 511. The IPv6 suffix 519 includes a subnet identifier (ID) 515 and a device ID 517 that indicate the subnet type 505 and the device name 507, respectively, and that collectively function as a host from an IPv6 perspective. In an example, the application subnet indicated by the subnet type 505 can also be hashed to bits in IPv6 following the application ID 513. In an example, the device indicated by the device name 507 may be hashed to device ID 517 and hence to bits at the end of the IPv6 prefix 519. For devices that are non-network nodes with limited capabilities, the device name 507 may not be hashed to an IPv6 device ID portion.

The preceding discussion is used when translating an LDN address into an IPv6 address at a border router to allow a packet to leave the LDN for transmission across the Internet. The border router may perform the process in reverse for transitioning a packet from the Internet back into the LDN. A mapping function may be applied to translate a global routing prefix 511 into an LDN name 501. When no mapping exists, the global routing prefix 511 can be dropped as no LDN name 501 is used inside the LDN in this case. The border router can apply a function to convert the application ID 513, the subnet ID 515, and the device ID 517 into the application type 503, the subnet type 505, and the device name 507, respectively. The function may be a hashing function with a mapping table and/or a reversible function.

LDN address spaces can be defined flexibly to capture semantics of end points in addressing structures. For multisite communications, assuming the global Internet employs IPv6 address format, traversing over the Internet may use different mechanisms to represent LDN addresses spaces into the IP address space. The LDN addresses may or may not fit into the 64-bit Host ID portion of IPV6 address. Several mechanisms can be considered. In some examples, the internal address space in the LDN address is within a 64-bit range. In this case, the LDN suffix 509 is captured as the IPv6 suffix 519, and the application type 503/application ID 513 represents the site.

Hashing schemes can be used as the function to perform a translation from LDN to IP space and back. For example, when the LDN address space deployed in the LDN is larger than 64 bits, hashing can be used to reduce the LDN address space to a 64-bit value that can be used as the IPv6 suffix 519. In an example, hashing can reduce large length semantic addresses to fixed length host-id bytes that fit in IP address space. Since hashing leads to collisions, an LDN site may maintain a reverse mapping with uniqueness guarantees. Smaller addresses can also be converted to 64-bit addresses. The disclosed hierarchical structure may be configured to use hashes for application, subnet, and device IDs that are computed independently. A management and/or control plane may signal hash functions and/or application names over secure channel between multiple sites to distribute and populate hash-mapping tables. The management plane can further choose policies for collisions, such as assigning application names that always generate a unique hash. Examples of hash functions include fletcher's sixteen-bit checksum (fletcher-16), cyclic redundancy check (CRC), checksum sixteen (SUM-16), message-digest algorithm five (MD5), and secure hash algorithm (SHA). It should be noted that hashes are irreversible, and hence reverse mapping may be required when converting back from IPv6 into the LDN address space.

Inverse Functions may also be used as the function to translate from LDN to IP space and back. By using inverse functions, the LDN address space can be used to obfuscate the LDN addresses, and hence can be used to maintain network layer privacy. For example, the address bits that traverse through IP networks cannot be directly/easily snooped upon. Inverse functions can prevent exposure of the LDN address space as-is when transiting the Internet. Distribution of which inverse function is deployed between a pair of sites can further enhance privacy. For additional security, a change in inverse functions used can be signaled to border routers on a periodic basis. Inverse functions may include f(x)=(x+10)/(x−3), f(x)=\sqrt{4x+24}, etc. Each domain can specify local inverse criteria based on the address space. The advantage is no mapping is necessary.

As an example, a function

$$f ( x ) = \sqrt{4 x + 24}$$

can be reversed by employing an inverted function, such as

$$f ( x ) = \frac{{y}^{2}}{4} - 24 .$$

This inverted function may be unique for only certain values of x, but such issues can be managed by other techniques. Many functions yield unique integer values for certain values of x. However, a discontinuous pair of f(x) and x values provides better security since a man in the middle may have difficulty in resolving such pairs to make correlation between the two endpoints by snooping addresses on the wire. Accordingly, employing functions that result in discontinuities in the address space may increase security.

In summary, the present disclosure includes a method to interconnect different protocols in industry control networks using asymmetric address and New IP without using encapsulations. An asymmetric address structure for Non-IP industry protocols and IP coordination is described with the following definitions. Asymmetric address structures mean many things—semantic, hierarchical, and/or encoded. Asymmetric address structures are referred to as user-defined AF or LDN AF. A user-defined address family is any address space that is defined to have significance over a predetermined network region, but may have no significance outside of the predetermined network region. A LDN address family is any address space defined over a LDN, such as a user-defined AF configured to have significance over the LDN. Any type of well-known or user-defined address formats are supported in source and destination. In this method, examples of non-IP addresses include Modbus, BACNet, and ProfiBus formats.

Since there is no fixed address length in LDN, a hierarchy of mixed formats and a mixed forwarding can be enabled, such as [4-bytes IP router] [2 bytes controller] [1 byte end-device]. This is a user defined address-family which is only interpreted in the LDN of an industrial network. In this format, mixed forwarding is performed. The top part forwarding in the network is done on the basis of IP and the subsequent part is done based on controller address family. The benefit of this approach is to support both IP and non-IP forwarding rules together. A semantic address can be used to fully describe names in user understandable or readable strings. E.g., monitor_App/floor/room/temp_sensor. An encoded address is defined for boundary protocol.

The disclosed method describes the procedures for inside, outside, and boundary protocols in LDNs. For the inside protocol, this method uses non-IP asymmetric address distribution (e.g., addresses that are not four bytes or sixteen bytes and headers that are not 20 bytes or 40 bytes as used in IPv4 and IPv6, respectively) and management of heterogeneous and non-IP addresses in LDNs. For each user-defined address family, the LDN operator defines the forwarding look up behavior. A New IP router supports one forwarding table for each address family (both IP and non-IP are supported). The router can use destination address and address type to look up addresses in forwarding tables and determine next hop information. For the outside protocol, forwarding is performed as IPv6. For the boundary protocol, translations from inside protocol addresses (e.g., LDN addresses) to outside protocol addresses (IPv6 addresses) are proposed to maintain pure IP forwarding in the Internet using hashing and/or inverse functions. A use case includes interconnecting multiple sites of the same LDN. An IPv6 global routing prefix is a globally known prefix for LDN. IPv6 provider-based techniques can be used to secure global prefixes.

The LDN address translation can be done in the suffix part of the IPv6 address format. A domain ID can be used to interconnect among other remote sites of the same domain and among different domains. A less specific prefix ‘org domain’ such as 64-bits of a network prefix can be a domain ID and other site ID. Procedures for suffix translation include hashing of addresses used in LDN address space such as hierarchical, semantic, syntactic as explained in previous paragraphs to fit into IPv6 suffix. LDN addresses can be hashed into the IPv6 suffix for traversal over the IP internet, but a reverse mapping table can be used to recreate the LDN addresses. Inverse functions can be used for privacy enhancement. The LDN space may be the same size or smaller than the IPv6 suffix. In this case, inverse functions can be used to obfuscate (mask) the bits through IP networks.

The present disclosure includes a network device within a limited-domain network. The network device is configured to generate a packet comprising a destination address and a source address, the destination and the source address having different formats; and forward the packet towards the destination address. The destination address can be shorter than an IPv6 address. The destination address can be longer than an IPv6 address. The destination address and source address can have different lengths.

A network device can also be configured to receive a packet comprising different formats; and can process the packet based on its destination address format. This can include using different non-IP/multiprotocol label switching (MPLS) FIB look up tables per address families.

A limited domain network may comprise a plurality of network devices, where each network device is configured to process packets comprising destination and source addresses with different formats. The plurality of network devices may each comprise a forwarding table for translating an address of any of the address formats used in the network to an output interface of the network device.

A network gateway device can be positioned between a limited-domain network and an IPv6 network. The network gateway device can be configured to receive an outbound packet from the limited-domain network, the packet comprising a destination address comprising a non-IPv6 address; translate the non-IPv6 address into an IPv6 address; update the destination address in the packet with the IPv6 address; and forward the packet to the IPv6 network. Translating the non-IPv6 address into an IPv6 address may comprise using a hash algorithm, an encryption function, a translation table, an inverse function, or combinations thereof. The non-IPv6 address can be shorter, longer, and/or different than an IPv6 address.

A network gateway device can be positioned between a limited-domain network and an IPv6 network. The network gateway device can be configured to receive an inbound packet from the IPv6 network, the packet comprising a destination address comprising an IPv6 address; translate the IPv6 address into a non-IPv6 address used within the limited-domain network; update the destination address in the packet with the non-IPv6 address; and forward the packet to the limited-domain network

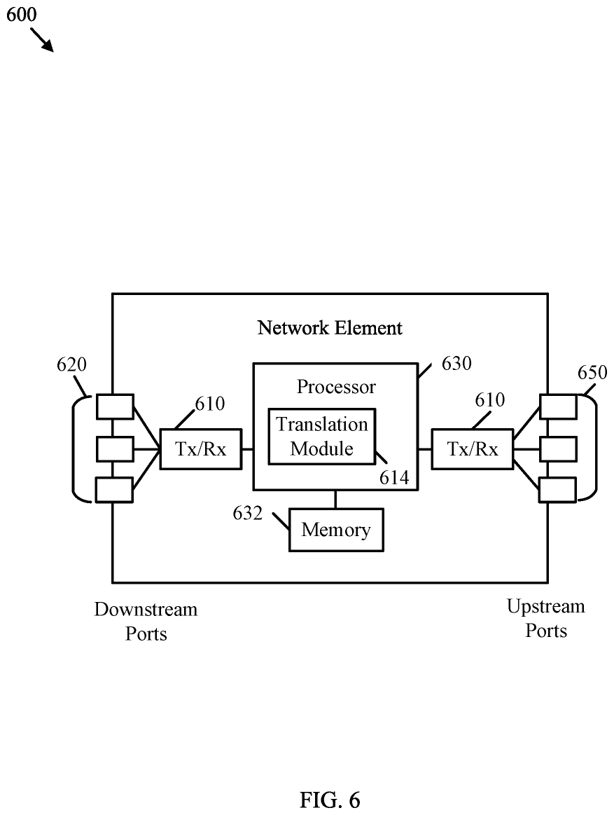

FIG. 6 is a diagram of an example network element 600. The network element 600 is suitable for implementing the disclosed examples/embodiments as described herein. The network element 600 comprises downstream ports 620, upstream ports 650, and/or transceiver units (Tx/Rx) 610, including transmitters and/or receivers for communicating data upstream and/or downstream over a network. The network element 600 also includes a processor 630 including a logic unit and/or central processing unit (CPU) to process the data and a memory 632 for storing the data. The network element 600 may also comprise electrical, optical-to-electrical (OE) components, electrical-to-optical (EO) components, and/or wireless communication components coupled to the upstream ports 650 and/or downstream ports 620 for communication of data via electrical, optical, or wireless communication networks. The network element 600 may also include input and/or output (I/O) devices for communicating data to and from a user. The I/O devices may include output devices such as a display for displaying image and/or video data. The I/O devices may also include input devices, such as a keyboard, mouse, trackball, etc., and/or corresponding interfaces for interacting with such output devices.

The processor 630 is implemented by hardware and software. The processor 630 may be implemented as one or more CPU chips, cores (e.g., as a multi-core processor), field-programmable gate arrays (FPGAs), application specific integrated circuits (ASICs), and digital signal processors (DSPs). The processor 630 is in communication with the downstream ports 620, Tx/Rx 610, upstream ports 650, and memory 632. The processor 630 comprises a translation module 614. The translation module 614 implements the disclosed embodiments described herein, such as mechanism 300, mechanism 500, method 700, and/or method 800, which may employ a packet, such as a New IP packet 400. The translation module 614 may also implement any other method/mechanism described herein. Further, the translation module 614 may implement functionality in a device in network 100 and/or LDN 200. For example, the translation module 614 may translate a New IP packet into an IPv6 packet and vice versa, for example by translating LDN address family based addresses into IP addresses and vice versa. Accordingly, the translation module 614 allows the definition and use of asymmetric addressing and allows for non-IP based networks to communicate over IPv6 networks without employing tunneling. As such, the translation module 614 improves the functionality of the network element 600 as well as addresses problems that are applicable to the image coding arts. Further, the translation module 614 affects a transformation of the network element 600 to a different state. Alternatively, the translation module 614 can be implemented as instructions stored in the memory 632 and executed by the processor 630 (e.g., as a computer program product stored on a non-transitory medium).

The memory 632 comprises one or more memory types such as disks, tape drives, solid-state drives, read only memory (ROM), random access memory (RAM), flash memory, ternary content-addressable memory (TCAM), static random-access memory (SRAM), etc. The memory 632 may be used as an over-flow data storage device, to store programs when such programs are selected for execution, and to store instructions and data that are read during program execution.

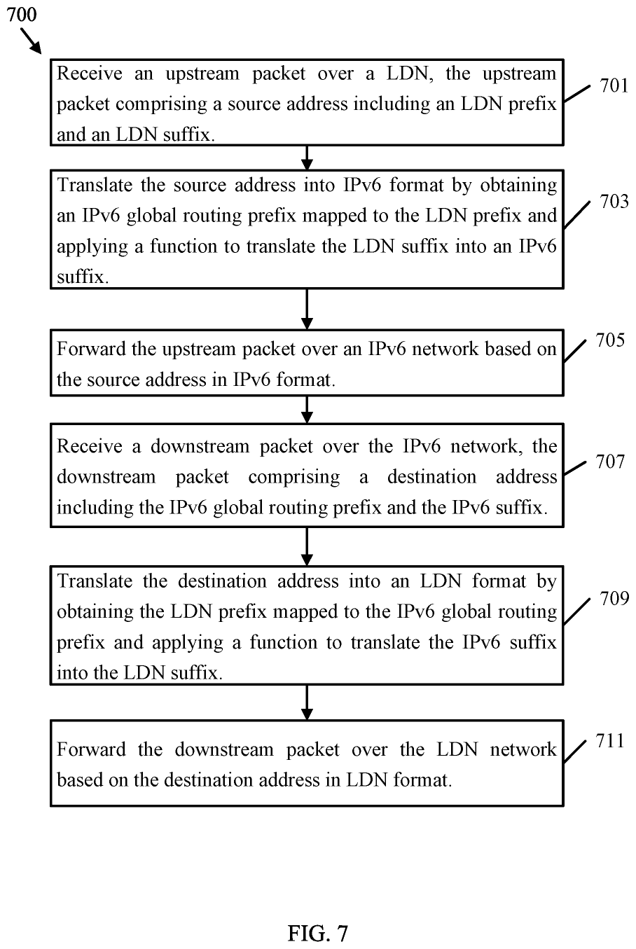

FIG. 7 is a flowchart of an example method 700 of translating addresses to support communication across a boundary between an LDN and an IP network. For example, method 700 can be implemented by a border router positioned between an LDN and an IP network, for example by employing a New IP packet and address translation.

At step 701, the border router receives an upstream packet over an LDN. In this context, an upstream packet is a packet from a device in an LDN addressed for a destination outside the LDN. The upstream packet comprises a source address including an LDN suffix and optionally an LDN prefix. In an example, the upstream packet, as received, comprises a destination address in IPv6 format and a source address in an LDN format.

At step 703, the border router translates the source address into IPv6 format by applying a function to translate the LDN suffix into an IPv6 suffix. When the LDN prefix is present, translating the source address into IPv6 format may include obtaining an IPv6 global routing prefix mapped to the LDN prefix. In some examples, the function may be a hash function, a reversible function, or combinations thereof. In some examples, the upstream packet is received as a New IP packet with the LDN prefix, the LDN suffix, or combinations thereof contained in a shipping specification. In some examples, the LDN suffix is in a user defined format without a fixed address length. For example, the LDN suffix may contain a device address in Modbus format, BACNet format, ProfiBus format, or combinations thereof. In an example, the LDN prefix is an LDN name, and the LDN suffix contains an application type, a subnet type, and a device name. For example, the function may translate the application type into an application ID, translate the subnet type into a subnet ID, and translate the device name into a device ID.

At step 705, the border router forwards the upstream packet over an IPv6 network based on the source address in IPv6 format.

At step 707, the border router may receive a downstream packet over the IPv6 network. In this context, a downstream packet is a packet from a device outside the LDN addressed for a destination inside the LDN. The downstream packet may or may not be responsive to the upstream packet. The downstream packet comprises a destination address including the IPv6 global routing prefix and an IPv6 suffix.

At step 709, the border router translates the destination address into an LDN format by applying a function to translate the IPv6 suffix into the LDN suffix. Translating the destination address into LDN format may include obtaining an LDN prefix mapped to the IPv6 global routing prefix. Translating the destination address into LDN format may include discarding the IPv6 global routing prefix, for example when an LDN prefix is not used inside the LDN.

A step 711, the border router forwards the downstream packet over the LDN network based on the destination address in LDN format. In some examples, the downstream packet, as forwarded, comprises a source address in IPv6 format and a destination address in LDN format. In some examples, the downstream packet is forwarded as a New IP packet with the LDN prefix and the LDN suffix contained in a shipping specification.

In some examples, the translations of step 703 and/or 709 are performed based on a FIB at the border router. The FIB can be updated based on ISIS protocol, OSPF protocol, BGP, or combinations thereof.

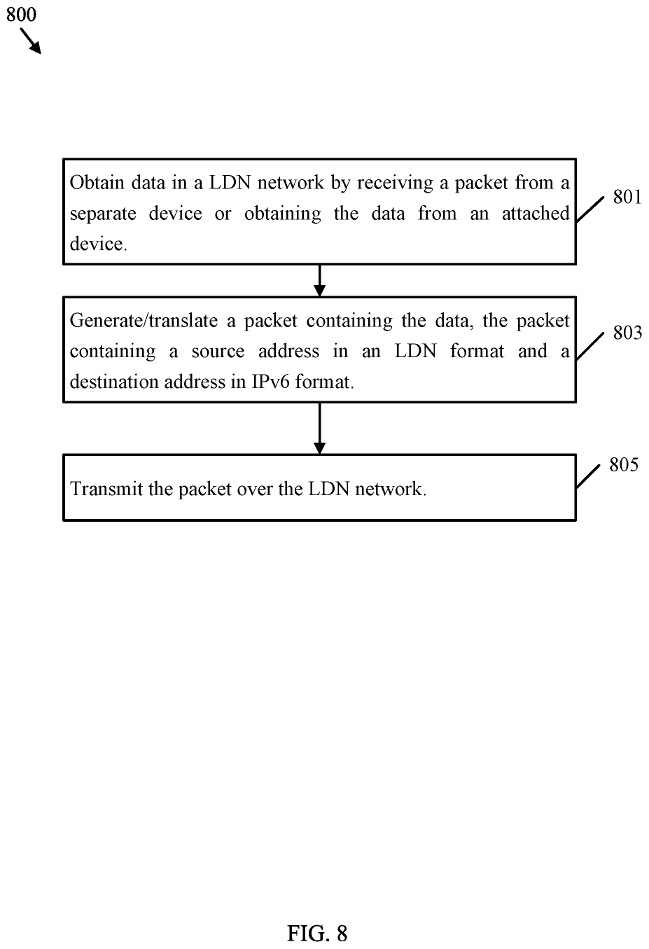

FIG. 8 is a flowchart of an example method 800 of communicating a packet containing addresses in both LDN and IP format. For example, method 800 can be implemented by a network device positioned in an LDN. The network device may or may not be configured to communicate with New IP.

At step 801, the network device obtains data in an LDN network. In some examples, the network device is a gateway, and obtaining the data includes receiving the data from a separate device. In some examples, the network device obtains the data from an attached device. For example, the network may comprise a sensor, and the data can be obtained by the sensor.

At step 803, the network device generates and/or translates a packet containing the data. The packet contains a source address in an LDN format and a destination address in IPv6 format. In some examples, the network device is a gateway, and generating the packet includes translating the data into a New IP format. In some examples, the LDN format includes an address in Modbus format, BACNet format, ProfiBus format, or combinations thereof. In some examples, the LDN format is in a user defined format without a fixed address length. In some examples, the LDN format includes an LDN name, an application type, a subnet type, and a device name.

At step 805, the network device transmits the packet over the LDN network. In some examples, the packet is a New IP packet with the source address and the destination address contained in a shipping specification.

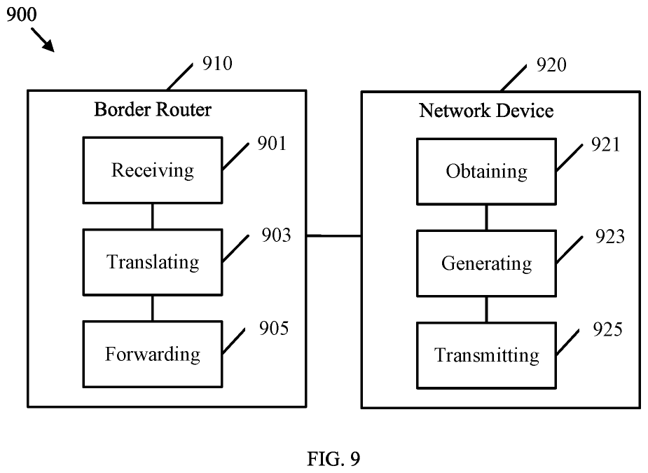

FIG. 9 is a diagram of an example system 900 for communicating data using addresses in LDN and IP formats. The system 900 may employ a border router 910, which may be implemented by a border router 117, a border router 217, a network element 600, or combinations thereof. The system 900 may also comprise a network device 920, which may be implemented by a new IP gateway 113, a device 111, a new IP device 115, a router in LDN 200, a network element 600, or combinations thereof. System 900 may be employed to implement mechanism 300, mechanism 500, method 700, method 800, or combinations thereof. The system 900 may also employ a new IP packet 400.

The system 900 includes a border router 910. The border router 910 includes a receiving module 901 for receiving an upstream packet over an LDN, the upstream packet comprising a source address including an LDN suffix. The border router 910 also includes a translating module 903 for translating the source address into IPv6 format by applying a function to translate the LDN suffix into an IPv6 suffix. The border router 910 also includes a forwarding module 905 for forwarding the upstream packet over an IPv6 network based on the source address in IPv6 format. The system 900 may be further configured to perform any of the steps of method 700.

The system 900 also includes a network device 920. The network device 920 includes an obtaining module 921 for obtaining data in an LDN network. The network device 920 also includes a generating module 923 for generating a packet containing the data, the packet containing a source address in an LDN format and a destination address in IPv6 format. The network device 920 also includes a transmitting module 925 for transmitting the packet over the LDN network. The system 900 may be further configured to perform any of the steps of method 800.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

It should also be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present disclosure.

While several embodiments have been provided in the present disclosure, it may be understood that the disclosed systems and methods might be embodied in many other forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method implemented by a border router, the method comprising:
receiving an upstream packet over a limited domain network (LDN), the upstream packet comprising a source address in LDN format including an LDN suffix;
translating the source address into Internet Protocol version six (IPv6) format by applying a function to translate the LDN suffix into an IPv6 suffix; and
forwarding the upstream packet over an IPv6 network based on the source address in IPv6 format as included in the upstream packet.

2. The method of claim 1, wherein the function is a hash function.

3. The method of claim 1, wherein the function is a reversible function.

4. The method of claim 1, wherein the source address in the LDN format includes an LDN prefix, and wherein the translating the source address in the LDN format into the IPv6 format includes obtaining an IPv6 global routing prefix mapped to the LDN prefix.

5. The method of claim 4, wherein the upstream packet is received as a New IP packet with the LDN prefix and the LDN suffix contained in a shipping specification.

6. The method of claim 1, wherein the LDN suffix is in a user defined format without a fixed address length.

7. The method of claim 1, wherein the LDN suffix contains a device address in one of: a Modbus format, a Building Automation and Control networks (BACNet) format, a Process Field Bus (ProfiBus) format, or combinations thereof.

8. The method of claim 4, wherein the LDN prefix is an LDN name, and wherein the LDN suffix contains an application type, a subnet type, and a device name.

9. The method of claim 8, wherein the function translates the application type into an application identifier (ID), translates the subnet type into a subnet ID, and translates the device name into a device ID.

10. The method of claim 1, wherein the upstream packet, as received, comprises a destination address in the IPv6 format and the source address in the LDN format.

11. The method of claim 4, further comprising:
receiving a downstream packet over the IPv6 network, the downstream packet comprising a destination address in the IPv6 format including the IPv6 global routing prefix and the IPv6 suffix;
translating the destination address into the LDN format by applying a second function to translate the IPv6 suffix into the LDN suffix; and
forwarding the downstream packet over the LDN based on the destination address in the LDN format.

12. The method of claim 11, wherein the translating the destination address into the LDN format includes obtaining the LDN prefix mapped to the IPv6 global routing prefix.

13. The method of claim 11, wherein the translating the destination address into the LDN format includes discarding the IPv6 global routing prefix.

14. The method of claim 11, wherein the downstream packet, as forwarded, comprises the source address in the IPv6 format and the destination address in the LDN format.

15. The method of claim 11, wherein the downstream packet is forwarded as a New IP packet with the LDN prefix and the LDN suffix contained in a shipping specification.

16. The method of claim 11, wherein the translating is performed based on a forwarding information base (FIB), and wherein the FIB is updated based on one of: an Intermediate System to Intermediate System (ISIS) protocol, an Open Shortest Path First (OSPF) protocol, a Border Gateway Protocol (BGP), or combinations thereof.

17. A method implemented by a network device, the method comprising:
obtaining data in a limited domain network (LDN);
generating a packet containing the data, the packet containing a source address in an LDN format and a destination address in an Internet Protocol version six (IPv6) format; and
transmitting the packet over the LDN.

18. The method of claim 17, wherein the LDN format includes an address in one of: a Modbus format, a Building Automation and Control networks (BACNet) format, a Process Field Bus (ProfiBus) format, or combinations thereof.

19. The method of claim 17, wherein the packet is a New IP packet with the source address and the destination address contained in a shipping specification.

20. The method of claim 17, wherein the LDN format is in a user defined format without a fixed address length.
